(19) United States
(12) Patent Application Publication
(10) Pub. No.: US 2003/0233869 A1
(43) Pub. Date: Dec. 25, 2003

(54) Turbine bucket vane surface finish comparator

(76) Inventor: Chris Robin Bron, Springfield, IL (US)

Correspondence Address: NIXON & VANDERHYE P.C./G.E., 1100 N. GLEBE RD., SUITE 800, ARLINGTON, VA, 22201, US

(21) Appl. No.: 10/464,755

(22) Filed: Jun. 19, 2003

Related U.S. Application Data
(63) Continuation-in-part of application No. 10/176,371, filed on Jun. 21, 2002.

(51) Int. Cl. G01N 17/00

(52) U.S. Cl. 73/86

(57) ABSTRACT

A comparator for determining a degree of erosion on a metallic surface of a part including a panel having a plurality of cells arranged on a side of the panel, wherein each cell has a surface finish representative of a certain surface condition of the part, and each surface condition replicates a degree of erosion on the metallic surface of the part.

### RELATED APPLICATION

This application is a continuation-in-part application of and claims priority to commonly owned U.S. Pat. No. ______ filed as U.S. patent application Ser. No. 10/176,371, on Jun. 21, 2002, which is incorporated by reference in its entirety.

### BACKGROUND OF THE INVENTION

Steam turbine bucket vanes experience surface erosion due to the steam that flows over their surfaces. Water droplets in the steam erode the surfaces of the bucket vanes, especially at their leading edges. As they erode, the vane surfaces become rough and pitted. Water may eroded the surface of a bucket vane to have a roughness greater than 5,500 micro-inches. The erode vane surfaces can increase the aerodynamic drag of the steam passing over the buckets and degrade the performance of the steam turbine.

Turbine bucket vanes erode gradually. Erosion, to a certain degree, is tolerated and does not require replacement or repair of a bucket vane. The extent of erosion is monitored during periodic inspections of the steam path components in a turbine. During inspection, the bucket vanes are manually inspected to determine if they have suffered too much erosion. The traditional techniques of categorizing water erosion of a turbine bucket vane rely upon photographs of surface erosion, upon cumbersome samples of eroded bucket vanes, and upon surface roughness measuring instruments. Blade erosion is a three-dimensional phenomena. The pitting and degradation due to steam of the surface finish alters the surface shape and texture on the turbine bucket vane. The three-dimensional effects of steam water erosion are not fully shown in a two-dimensional photograph. It is difficult to compare the photographs of surface erosion to the actual surfaces of a bucket vane, especially where the lighting and point of view of the actual bucket vane is different than those conditions in a photograph. Moreover, photographs do not enable an inspector to compare the tactile feel of an eroded surface of a bucket vane to a sequence of standard surfaces that have been ranked according to their degree of erosion.

A box of sections of eroded bucket vanes have been used as a tool for grading the erosion of a bucket vane in service. However, samples of eroded bucket vane sections are cumbersome. Further, measurement instruments, e.g., a portable electronic profilemeter, can measure surface roughness but are also cumbersome and require specialized training. Accordingly, there is a long felt need for an improved technique and apparatus for categorizing the degree of erosion on the surface of a steam turbine bucket or vane.

### BRIEF DESCRIPTION OF THE INVENTION

In a first embodiment, the invention is a comparator for determining a degree of erosion on a metallic surface of a part including a panel having a plurality of cells arranged on a side of the panel, wherein each cell has a surface finish representative of a certain surface condition of the part, and each surface condition replicates a degree of erosion on the metallic surface of the part.

In a second embodiment, the invention is a comparator for determining a surface finish condition on a steam turbine bucket vane comprising: a plate having a plurality of cells arranged on a side of the plate, wherein each cell has a surface finish representative of a certain degree of surface erosion of the bucket vane and wherein the surface finish of each cell is a three dimensional reproduction of surface erosion of the bucket vane.

### BRIEF DESCRIPTION OF THE DRAWINGS

FIG. 1 illustrates a bucket vane water erosion surface finish comparator device.

FIG. 2 shows a sequence of photographs of exemplary surface finishes of steam turbine bucket vanes.

### DETAILED DESCRIPTION OF THE INVENTION

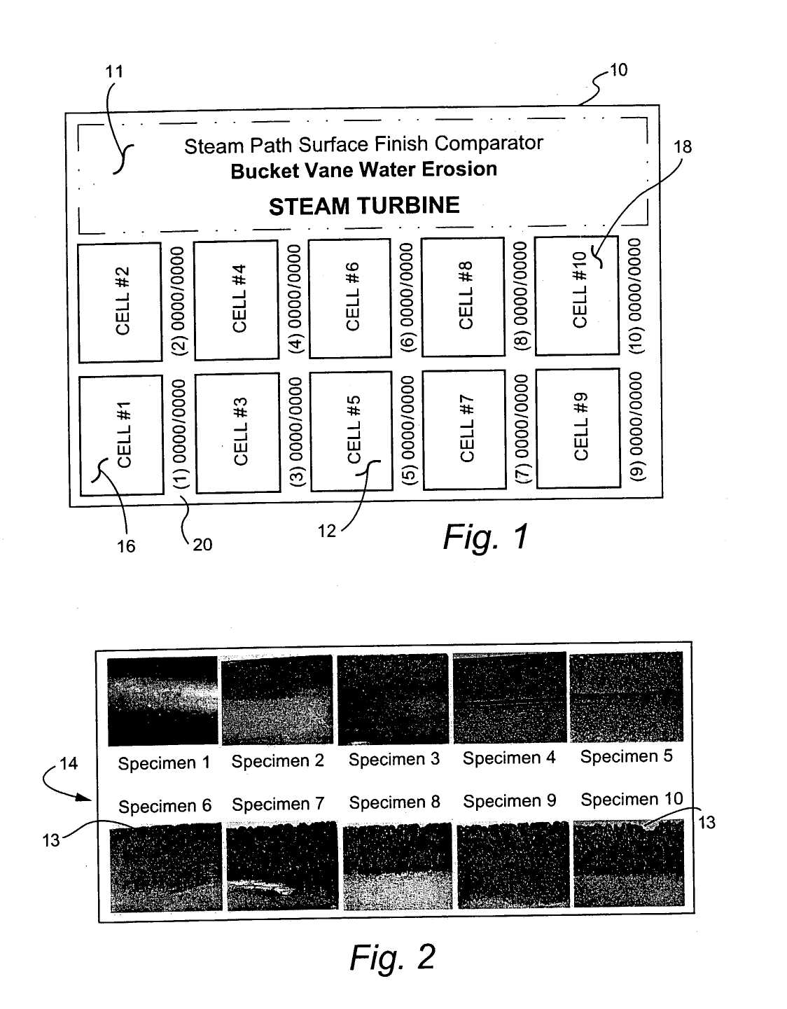

FIG. 1 illustrates a bucket vane water erosion surface finish comparator 10. The comparator is an easy to use hand-held tool to assist field service inspectors to evaluate turbine buckets and vanes in operational steam turbines. The comparator may include an identification panel 11 that identifies the class of steam turbine corresponding to the comparator.

The comparator 10 may be a thin pocket-sized panel having exemplary dimensions of approximately 4.8 inches (12 cm) long (L), 2.3 inches (5.8 cm) wide (W), and 0.045 inches (1.1 mm) thick. The comparator can be easily carried in a shirt pocket of an inspector. The comparator may be metallic or formed of another rigid and durable material. The comparator is formed of a material that can withstand field use, storage in toolboxes and other conditions that subject it to the environment and rough handling. Surface finish comparators have been previously made and sold for other purposes, but have not previously been available for categorizing the extend of erosion on a bucket vane.

The comparator 10 includes a panel of cells 12 of exemplary surface finishes. Each cell is a specimen of a surface finish on a bucket vane that has been eroded to a known degree. FIG. 2 shows a sequence of photographs 14 of the bucket vane surface finishes that may be reproduced in the cells 12 of the comparator. The surface represented in each cell may correspond to a leading edge 13 of a bucket vane. The cell surface may be formed to reproduce the leading edge 13 surface and a portion of the vane surface adjacent the leading edge.

Each cell 12 has a reproduced surface finish that has suffered a different degree of water erosion. The cells may be arranged on the comparator in order erosion. For example, a first cell 16 may have the surface finish of a new bucket vane that has no erosion. A last cell 18 may have a surface finish of a bucket vane that has suffered extreme water erosion. The cells from the first to the last cell may show a progression of surface finishes having increasing degrees of erosion.

Each cell 12 has a surface finish that reproduces the surface finish on a turbine bucket vane that has experienced a certain degree of erosion. The metal surface of the cell has been formed to have the same look and feel as the surface finish of an eroded bucket vane. The surface of the cell is a three-dimensional reproduction of a surface of a bucket vane. The surface of the cell is roughened and pitted in the same manner as is an eroded surface of a bucket vane. Further, the cell surface may also reproduce the leading edge 13 of the vane. An inspector can touch and view the cells to compare them to the actual surface of a bucket vane being inspected.

The inspector determines which cell 12 that is most similar to the surface of the bucket vane being inspected based on a visual and tactile comparison. Adjacent each cell is a label of the ranking or category 20 for the cell. Each cell is assigned a particular rank or category corresponding to the degree of erosion represented in the cell. For example, each cell may have a certain surface finish roughness and the associated rank 20 may be the range of surface roughness corresponding to the cell. The surface roughness may be in terms of micro-inches Ra or RMS (root mean squared).

By determining which cell has a surface finish most similar to that of a bucket vane, the rank or category of that cell may be recorded as the current surface finish condition of the bucket vane. By using the comparator 10 to categorize the current surface condition of a bucket vane, the rank or category information may be applied in determining the condition of the bucket vane and the thermodynamic performance effects of the surface condition of the bucket vane. For example, knowing the approximate surface roughness of the bucket vanes in a steam turbine can be used to determine the thermodynamic performance loss in the turbine due to water erosion bucket vane components.

The cells of the comparator may be formed by an process that replicates the surface finish on a bucket or vane of a steam turbine. The various degrees of surface roughness and conditions may be selected to correspond to the surface erosion conditions that are actually occurring in operating steam turbines. The number of cells and the categories and/or ranks of cells may correspond to system for inspecting and evaluating buckets and vanes (and which is beyond the scope of this invention). The manner in which the surface finish in each cell is formed is also outside the scope of this invention. The surface finish may be formed by a electroformed nickel molding process. The surface finish of some of the cells may be quite rough and, for example, represent surface erosion in excess of 1000 to 5,500 micro-inches Ra or RMS.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A comparator for determining a degree of erosion on a metallic surface of a part comprising:
a panel having a plurality of cells arranged on a side of the panel, wherein each cell has a surface finish representative of a certain surface condition of the part, and each surface condition replicates a degree of erosion on the metallic surface of the part.

2. A comparator as in claim 1 wherein the part is a turbine bucket.

3. A comparator as in claim 1 wherein the part is a steam turbine bucket vane.

4. A comparator as in claim 1 wherein the surface condition is surface roughness due to erosion by steam flowing across the metallic surface.

5. A comparator as in claim 1 wherein the plurality of cells each correspond to a different degree of water erosion on the metallic surface.

6. A comparator as in claim 1 wherein the plurality of cells each correspond to a different degree of water erosion due to steam flowing across the metallic surface of a steam turbine bucket vane.

7. A comparator as in claim 1 wherein the surface finish in each cell is a three dimensional reproduction of surface erosion of the metallic surface of the part.

8. A comparator as in claim 1 wherein each of the plurality of cells has an associated category or rank indicia on the comparator.

9. A comparator as in claim 1 wherein the surface condition replicated in a leading edge of the metallic surface.

10. A comparator for determining a surface finish condition on a steam turbine bucket vane comprising:
a plate having a plurality of cells arranged on a side of the plate, wherein each cell has a surface finish representative of a certain degree of surface erosion of the bucket vane and wherein the surface finish of each cell is a three dimensional reproduction of a surface of the bucket vane.

11. A comparator has in claim 10 wherein the panel has a thickness of less than 0.1 inch, a width of less than four inches and a length of less than six inches.

12. A comparator as in claim 10 wherein the plurality of cells are arranged in order of increasing surface roughness of the surface represented by each cell.

13. A comparator as in claim 10 further comprising a rank or category assigned to each cell and indicia identifying the rank or category proximate each cell.

14. A comparator as in claim 13 wherein the rank or category is a range of surface roughness.

15. A comparator as in claim 10 wherein the surface of the bucket vane reproduced in each cell comprises a leading edge of the bucket vane.
